(19) United States
(12) Patent Application Publication
(10) Pub. No.: US 2006/0110206 A1
(43) Pub. Date: May 25, 2006

(54) Combination face scrubber and lotion dispenser

(76) Inventor: James R. Scribner, Sun Valley, CA (US)

Correspondence Address: LITMAN LAW OFFICES, LTD, PO BOX 15035, CRYSTAL CITY STATION, ARLINGTON, VA, 22215, US

(21) Appl. No.: 11/283,887

(22) Filed: Nov. 22, 2005

Related U.S. Application Data
(60) Provisional application No. 60/630,238, filed on Nov. 24, 2004.

(51) Int. Cl. B43K 5/14; B43K 8/04

(52) U.S. Cl. 401/134; 401/133; 401/196

(57) ABSTRACT

A disposable, single use combination face scrubber and lotion dispenser is formed of a loosely packed polyester material, folded around a plastic film inner container which serves as a breachable cleansing lotion reservoir. The inner container is generally spherical in shape when filled with lotion and sealed. The edges of the pad are then gathered together and secured by a clip or string to form a ball with a handle extending therefrom for grasping between the thumb and fingers of the user. A portion of the wall, or the mouth, of the inner container may be pinched and tied off by a release string, the string extending through the polyester pad. The inner bag is breached or opened by pulling the release string, releasing lotion into the pad. Other alternative means (e.g., a pin, etc.) may be used to breach the inner container.

### CROSS-REFERENCE TO RELATED APPLICATION

This application claims the benefit of U.S. Provisional Patent Application Ser. No. 60/630,238, filed Nov. 24, 2004.

### BACKGROUND OF THE INVENTION

1. Field of the Invention

The present invention relates to facial cleansing and scrubbing articles. More particularly, the present invention relates to disposable, single use facial cleansing and scrubbing articles containing an integral source of cleansing material or other topical liquid or gel.

2. Description of the Related Art

Applicators for cleansing the face are widely used. They are particularly useful for the removal of makeup applied to the face. Such applicators are used to distribute a cleansing solution, face cream, or the like to the face and also act as a pad for rubbing against the skin (scrubbing) to cleanse the face. The cleansing substance may be separately applied to the pad or the face and the pad scrubs the face to obtain a cleansing action. The applicator may have a compartment in which a bar of soap is inserted and, upon wetting, the soap may be distributed and lathered on the face through the porous wall of the applicator. Many such applicators have the drawback that they are intended to be used repeatedly, resulting in the necessary storage of the wet, soiled applicator between uses until the soap bar is consumed. The use of such scrubbing pads to exfoliate the skin is also practiced.

It would be desirable to provide a combination scrubbing pad and mildly abrasive applicator for cleansing and exfoliating the skin of the face, which device is disposable, having a supply of face lotion or the like within the applicator for convenient single use. The applicator and cleansing or scrubbing applicator would be easily packaged for distribution and storage and subject to easy disposal after use.

Thus an article useful to scrub the face solving the aforementioned problems is desired.

### SUMMARY OF THE INVENTION

The combination face scrubber and lotion applicator or dispenser of the present invention is a beauty and/or hygienic aid which allows the convenient and safe scrubbing and cleansing of the face. The combination scrubber is particularly useful for removing makeup and is disposable after one use. The outer material of the scrubber is preferably a pad of mildly abrasive, loosely woven or gathered polyester material about one half inch thick, similar to batting material used in stuffing pillows and upholstery. An example of such material is known by the brand name Kodel®, with an example of the polyester fibers being known under the trade name, Dacron®. The pad is folded around a sealed, flexible plastic inner container, which acts as a breachable cleansing lotion reservoir. The inner container is preferably generally spherical in shape when filled with lotion and is sealed during its manufacture. The edges of the pad are then bunched together and secured by a clip or string to form a ball with a handle extending therefrom for grasping between the thumb and fingers of the user.

The inner container may be ruptured by a pinprick, releasing the lotion into the pad for use. In a preferred embodiment, a portion of the wall of the inner container is bunched and tied off by a release string, the string extending through the fibrous polyester pad. The wall of the inner container is breached by the user pulling on the release string, which tears the bag wall, releasing lotion into the pad for use. Alternatively, the string may be secured about the mouth of the bag or container, and passed through the wall of the fibrous polyester scrubbing pad to secure about a portion of the external pad to form the handle portion of the device. A further alternative is a provision for a supplemental polyester pad between the wall of the inner lotion container and the outer fibrous polyester scrubbing pad, to compensate for the compression of the device in packaging.

It is an aspect of the invention to provide improved elements and arrangements thereof for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is an environmental, perspective view of the combination face scrubber of the present invention.

FIG. 2 is a perspective view, partially cut away, of the combination face scrubber of the present invention.

FIG. 3 is a perspective view, partially cut away, of the combination face scrubber of FIG. 1, showing a pricking pin.

FIG. 4 is a perspective view of another embodiment of the face scrubber of FIG. 1, partially cut away.

FIG. 5 is a view, partially cut away, of the embodiment of FIG. 4 showing the inner bag breached.

FIG. 6 is a detailed perspective view in partial section of an alternative embodiment incorporating a continuous release string loop and a supplemental pad.

Similar reference characters denote corresponding features consistently throughout the attached drawings.

### DETAILED DESCRIPTION OF THE PREFERRED EMBODIMENTS

The present invention is a combination face scrubber and lotion dispenser and applicator containing a breachable reservoir of cleansing cream or the like within a generally spherical scrub pad for one time use.

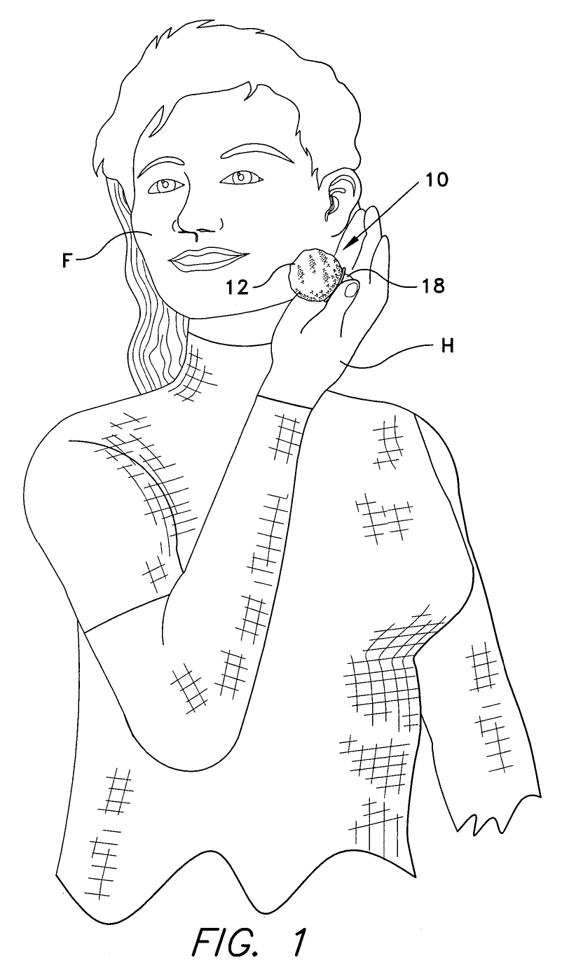

Referring to FIGS. 1-3, there is shown an environmental perspective view, and two partially cut away perspective views, respectively, of the combination scrub pad of the present invention, referred to by the reference number 10. As seen in FIG. 1, combination scrub pad system 10 includes a generally spherical scrub pad 12 having a bunched handle portion 18 held in the hand H as applied to the user's face F.

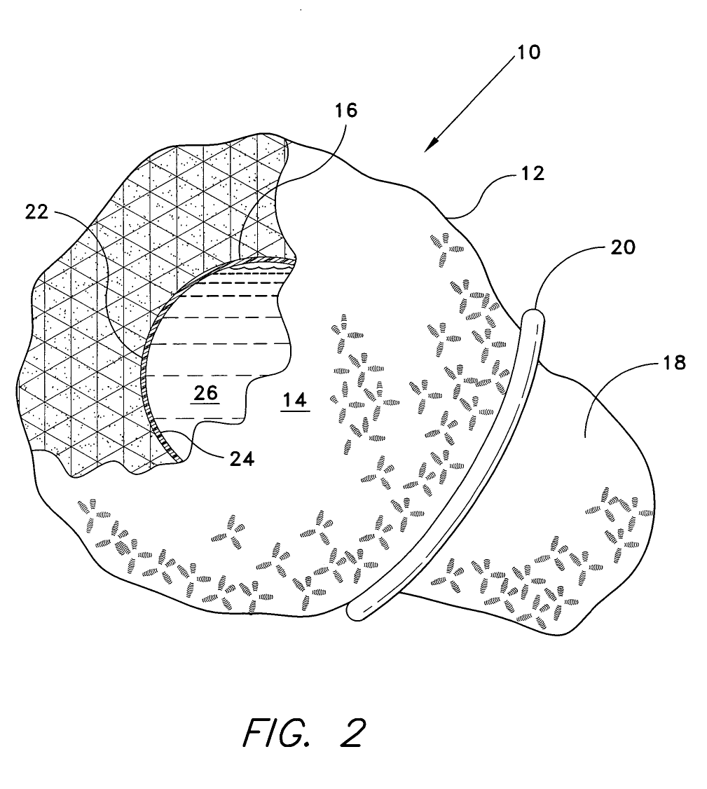

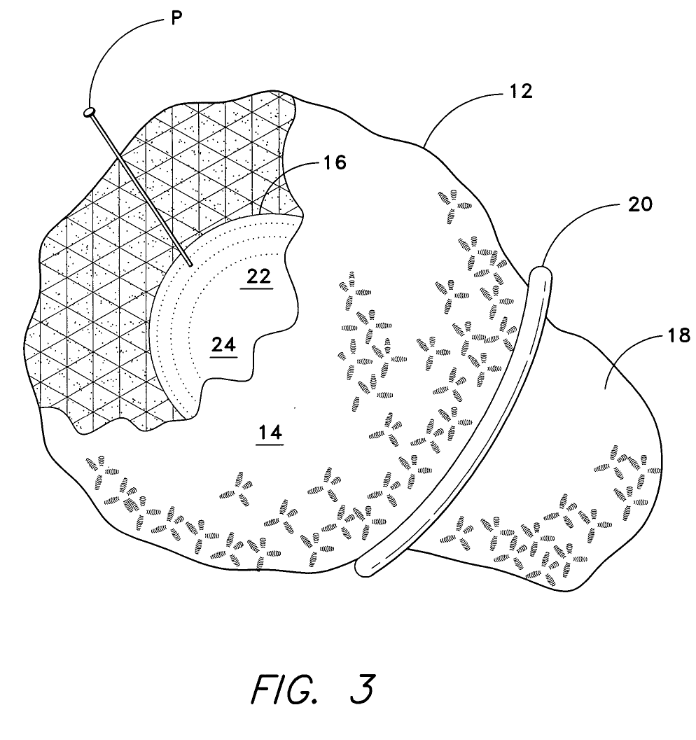

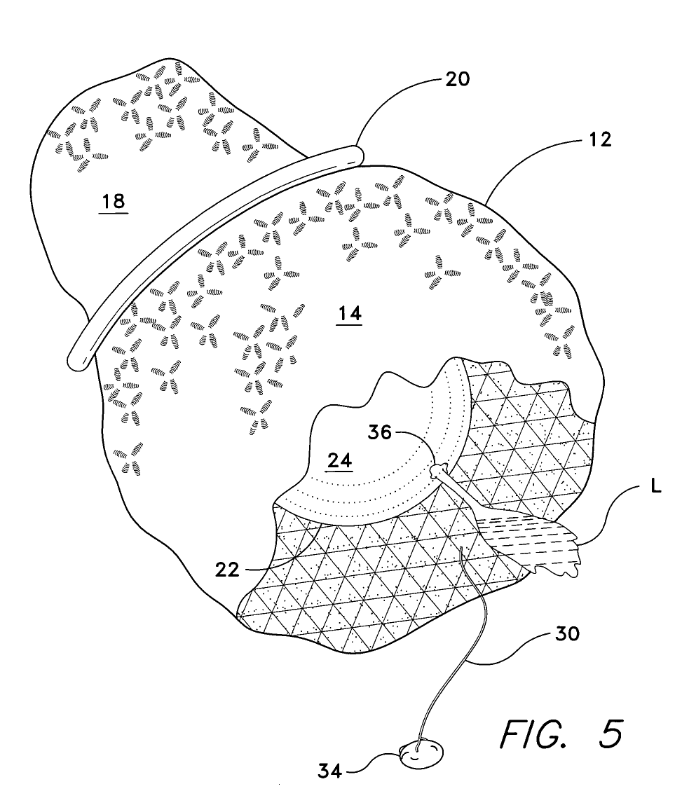

As best seen in FIG. 2, combination scrub pad system 10 includes a generally spherical scrub pad 12 (partially cut away) and having an outer surface 14 and an inner surface 16 bunched to form handle portion 18 secured by clip 20. Pad 12 surrounds inner bag reservoir 22 having a wall 24 of thin, flexible plastic material containing cleansing lotion 26. As seen in FIG. 3, a pin P is inserted into inner bag reservoir 22 to release cleansing lotion 26 into the scrub pad 12 (see FIG. 5).

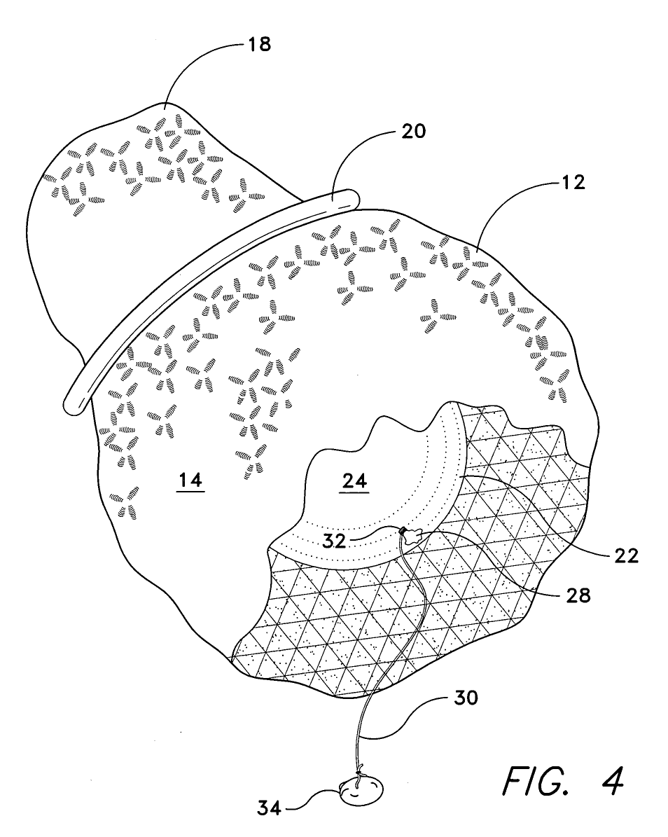

Referring to FIGS. 4 and 5, there are shown perspective views of a preferred embodiment of the present invention before breach and after breach, respectively, of the thin flexible wall 24 of the inner bag reservoir 22. In this embodiment a pinched portion 28 of the wall 24 is secured by a release string 30 by knot 32. Release string 30 extends through the spherical pad 12 and ends at a tassel or grip (e.g., button, knot, etc.) 34 for ease in grasping string 30. In order to release the lotion L, as seen in FIG. 5, release string 30 is pulled away, creating a breach rip 36 in inner bag reservoir 22 in the flexible wall 24. (The term “string” as used in the present disclosure may include any practicable form of elongate flexible material, e.g. thread, cord, twine, etc.) The lotion L then flows into the pad 12 for use in cleansing, scrubbing, and exfoliation of the skin of face F (see FIG. 1).

The scrub pad 12 is preferably formed of loosely woven or packed polyester fibers (e.g., Dacron®), similar to material used in pillow and upholstery stuffing and the like. An example of such material is known by the trade name Kodel®. However, any appropriate material which is porous and mildly abrasive may be employed to make to pad. Such material is mildly abrasive when applied to the skin, and serves to exfoliate the epidermis to remove loose and/or dead cells therefrom. The inner bag reservoir 22 is of thin, flexible plastic film or the like which may be ruptured with relative ease. The cleansing lotion 26 is any commercially available cleansing lotion, but other fluid materials may be stored in the reservoir as desired for application to the face or other part of the body. The clip 20 may be metal or plastic of sufficient strength to secure the scrub padding around the inner bag reservoir.

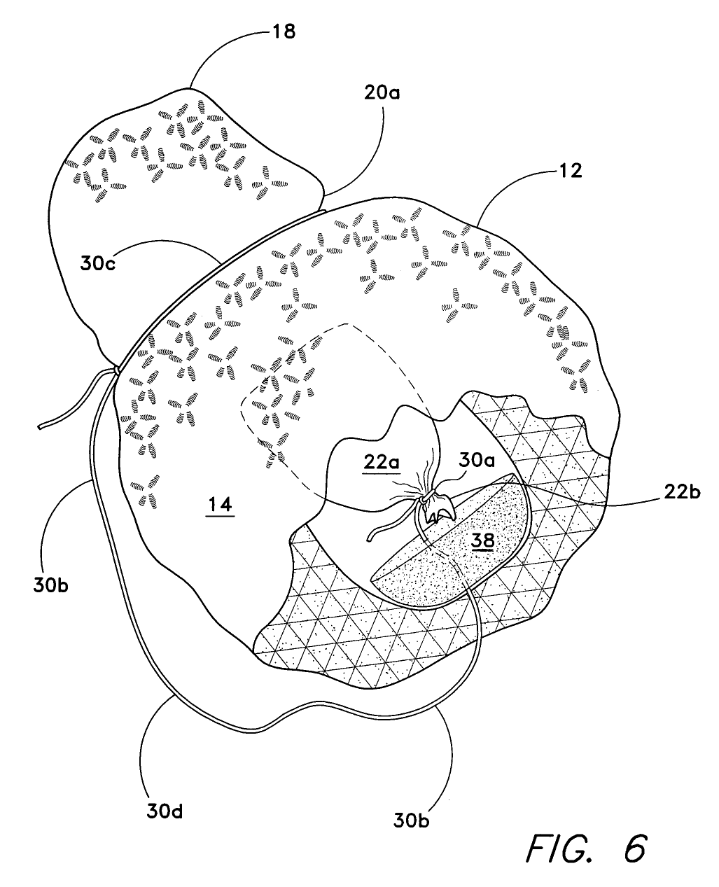

FIG. 6 provides an illustration of a further alternative embodiment of the present single use face scrubber and lotion dispenser. In FIG. 6, a thin walled, flexible plastic bag 22a is substituted for the invaginated flat plastic sheet 22 used to form the reservoir of FIGS. 2 through 5. The plastic bag reservoir 22a includes a mouth 22b, which is removably secured by the inner or first end 30a of a release string 30b to releasably seal the lotion contents within the plastic bag reservoir 22a. The release string 30b passes through the material of the outer scrub pad 12, and continues externally to the scrub pad 12 with its opposite second or external end 30c being used to tie or secure around the scrub pad 12 and form the narrowed closure neck 20a and handle portion 18 for the scrub pad 12. The medial portion 30d of the string 30b forms a closed loop external to the scrub pad 12, as shown in FIG. 6. A supplemental filler pad 38 may be provided within the outer scrub pad 12, but external to the inner bag or reservoir 22a (or plastic sheet reservoir 22 of FIGS. 2 through 5), in order to compensate for compression due to packaging.

The present combination facial scrubber and lotion dispenser in its various embodiments may be formed to have any practicable size, as desired. For an exemplary scrub pad, a 5″ square of ½ thick Kodel® padding is cut. The plastic inner reservoir bag material is cut to a 4″ square. About 7.5 m. of cleansing lotion, makeup removing lotion or other lotion is placed in the center of the plastic, the outside corners gathered and twisted until a spherical shape is formed which is tied off. The wall is pinched and the pinched portion tied off by the release string. The release string is threaded through the pad and a tassel tied to its free end. The pad is then folded over the lotion reservoir and the corners bunched and secured by the clip. The corners are trimmed to form a neat handle portion. The finished combination scrub pad may be wrapped in paper or the like for distribution and storage until used.

Alternatively, a small plastic bag about 1-½ to 2 inches across may be provided for the inner reservoir. The bag is filled with about the same amount of lotion as described above, depending upon the size of the bag, and the mouth of the bag is tied closed by the release string, to seal the bag. The release string is passed through the wall of the outer scrub pad, with the distal end either terminating in a tassel or other grip, or extended to secure about the otherwise open end of the outer scrub pad to close the pad about the inner reservoir and form a relatively narrow closure neck with the handle portion extending therefrom. The device is used in much the same manner as described further above, i.e. the outer scrub pad is moistened (either separately or by the moisture of the user's dampened face and/or skin) and the string is pulled to open the mouth of the internal lotion bag. The lotion flows from the bag to saturate the porous outer scrub pad for use.

While specific dimensions for some examples of the present device are noted further above, it will be noted that the device may be formed to have any practicable dimensions as desired. The dimensions noted further above are suitable for forming a relatively small device for use on the face of the user. However, even smaller devices may be formed in accordance with the present invention, perhaps even down to the size of a small cotton swab, or larger variations formed in order to provide sufficient lotion quantity and applicator size to cover essentially the entire body, as desired. In any event, the economy of manufacture of the device provides for economic single use, with the device being conveniently discarded after the single use.

Examples of lotions useful in the present invention include Pond's Deep Cleansing Lotion and Makeup Remover with Cucumber Extract, Dr. Bronner's 18-in-1 Hemp Almond Pure-Castile soap, Panthenol cleanser, Male Species Hydrating Face Wash with Aloe, and Rachel Perry Spearmint Leaf Revitalizing Face Wash.

It is to be understood that the present invention is not limited to the embodiments described above, but encompasses any and all embodiments within the scope of the following claims.

I claim:

1. A combination face scrubber and lotion dispenser, comprising:
a generally spherical, normally liquid impervious but breachable plastic-walled inner reservoir;
a quantity of lotion disposed within said reservoir;
a mildly abrasive, porous outer scrub pad folded around said inner reservoir, completely enclosing said inner reservoir within said outer scrub pad;
an outer scrub pad closure disposed about a portion of said outer scrub pad, gathering said outer scrub pad about said inner reservoir to form a generally spherical face scrubber portion and defining a narrow closure for said outer scrub pad;
a handle portion formed of a portion of said outer scrub pad, extending generally radially from said outer scrub pad closure; and
an inner reservoir breaching mechanism;
whereby upon breaching said inner reservoir, said lotion flows from the breach into said porous outer face scrubber portion for use in scrubbing a user's face.

2. The combination face scrubber and lotion dispenser of claim 1, wherein said outer scrub pad closure is a clip.

3. The combination face scrubber and lotion dispenser of claim 1, wherein said outer scrub pad closure is a string.

4. The combination face scrubber and lotion dispenser of claim 1, wherein said inner reservoir is a flat plastic sheet invaginated to form a closed container.

5. The combination face scrubber and lotion dispenser of claim 1, wherein said inner reservoir is a plastic bag having a closed mouth portion to form a closed container.

6. The combination face scrubber and lotion dispenser of claim 1, wherein said inner reservoir breaching mechanism comprises an inner reservoir breaching pin.

7. The combination face scrubber and lotion dispenser of claim 1, wherein said inner reservoir breaching mechanism comprises:
a protruding pinched portion extending from said plastic-walled inner reservoir;
a release string having an inner end secured about said pinched portion of said inner reservoir;
said release string further including a medial portion extending through said outer scrub pad, and an outer end opposite said inner end;
whereby said inner reservoir is breached at the pinched portion thereof when said release string is pulled to tear said inner reservoir, with said lotion flowing through the breach into said outer scrub pad.

8. The combination face scrubber and lotion dispenser of claim 7, further including a grip disposed upon the outer end of said release string.

9. The combination face scrubber and lotion dispenser of claim 7, wherein the outer end of said release string comprises said outer scrub pad closure, with said release string forming a closed loop external to said outer scrub pad between the inner end and the outer end.

10. The combination face scrubber and lotion dispenser of claim 1, wherein said inner reservoir breaching mechanism comprises:
said inner reservoir comprising a plastic bag having a closed mouth portion, forming a closed container;
a release string having an inner end removably securing the closed mouth portion of the plastic bag;
said release string further including a medial portion extending through said outer scrub pad, and an outer end opposite said inner end, the outer end of said release string comprising said outer scrub pad closure; and
said release string forming a closed loop external to said outer scrub pad between the inner end and the outer end;
whereby the mouth of the plastic bag forming said inner reservoir is opened when said release string is pulled, with said lotion flowing through the open mouth into said outer scrub pad.

11. The combination face scrubber and lotion dispenser of claim 1, further including a supplemental filler pad disposed within said outer scrub pad and external to said inner reservoir.

12. The combination face scrubber and lotion dispenser of claim 1, wherein said outer scrub pad comprises a loosely woven batt of fibrous polyester material.

13. A method of treating the skin using the combination face scrubber and lotion dispenser of claim 1, comprising the following steps:
(a) moistening the outer scrub pad with water;
(b) breaching the inner reservoir, thereby releasing the lotion therein and moistening the porous outer scrub pad with the lotion; and
(c) scrubbing the skin with the outer scrub pad, thereby simultaneously exfoliating loose skin particles and applying the lotion to the skin.

14. The method of treating the skin according to the method of claim 13, wherein the step of breaching the inner reservoir comprises penetrating the outer scrub pad and the inner reservoir with a pin.

15. The method of treating the skin according to the method of claim 13, wherein the step of breaching the inner reservoir comprises:
(a) pinching a portion of the inner reservoir;
(b) securing the inner end of the release string about the pinched portion of the inner reservoir;
(c) extending the release string through the outer scrub pad; and
(d) pulling the release string, thereby tearing the inner reservoir and releasing the lotion therein and saturating the porous outer scrub pad.

16. The method of treating the skin according to the method of claim 13, wherein the step of breaching the inner reservoir comprises:
(a) providing a plastic bag having a mouth portion, for the inner reservoir;
(b) removably securing the inner end of a release string about the mouth portion of the bag, thereby forming a closed container;
(c) extending the release string through the outer scrub pad;
(d) securing the outer end of the release string about the outer scrub pad, thereby forming the narrow closure; and
(e) pulling the release string, thereby loosening the inner end of the string from the mouth portion of the bag, releasing the lotion therein and saturating the porous outer scrub pad with the lotion.

17. A method of treating the skin using a combination face scrubber and lotion dispenser, comprising the following steps:
(a) providing an inner reservoir;
(b) filling the inner reservoir with lotion;
(c) completely enclosing the inner reservoir in a mildly abrasive, porous outer scrub pad;
(d) moistening the outer scrub pad with water;
(e) breaching the inner reservoir, thereby releasing the lotion therein and moistening the porous outer scrub pad with the lotion; and
(f) scrubbing the skin with the outer scrub pad, thereby simultaneously exfoliating loose skin particles and applying the lotion to the skin.

18. The method of treating the skin according to the method of claim 17, wherein the step of breaching the inner reservoir comprises penetrating the outer scrub pad and the inner reservoir with a pin.

19. The method of treating the skin according to the method of claim 17, wherein the step of breaching the inner reservoir comprises:
(a) pinching a portion of the inner reservoir;
(b) securing the inner end of a release string about the pinched portion of the inner reservoir;
(c) extending the release string through the outer scrub pad; and
(d) pulling the release string, thereby tearing the inner reservoir and releasing the lotion therein and saturating the porous outer scrub pad.

20. The method of treating the skin according to the method of claim 17, wherein the step of breaching the inner reservoir comprises:
(a) providing a plastic bag having a mouth portion, for the inner reservoir;
(b) removably securing the inner end of a release string about the mouth portion of the bag, thereby forming a closed container;
(c) extending the release string through the outer scrub pad;
(d) securing the outer end of the release string about the outer scrub pad, thereby forming the narrow closure; and
(e) pulling the release string, thereby loosening the inner end of the string from the mouth portion of the bag, releasing the lotion therein and saturating the porous outer scrub pad with the lotion.
